(19) United States
(12) Patent Application Publication
(10) Pub. No.: US 2016/0259618 A1
(43) Pub. Date: Sep. 8, 2016

(54) PLAYBACK SYSTEM, HEADPHONES, PLAYBACK APPARATUS AND METHOD, AND RECORDING MEDIUM AND PROGRAM FOR CONTROLLING PLAYBACK APPARATUS AND METHOD

(71) Applicant: Sony Corporation, Tokyo (JP)

(72) Inventor: Junichi Rekimoto, Tokyo (JP)

(21) Appl. No.: 15/153,418

(22) Filed: May 12, 2016

Related U.S. Application Data
(63) Continuation of application No. 11/155,487, filed on Jun. 20, 2005.

(30) Foreign Application Priority Data
Jul. 6, 2004 (JP) 2004-198787

(51) Int. Cl. G06F 3/16; H04R 29/00; H04R 1/10

(52) U.S. Cl. CPC G06F 3/162; H04R 1/1041; H04R 29/001; G06F 3/165; H04R 2460/03

(57) ABSTRACT

A playback system includes headphones worn on a user's body and converting an electrical signal into sound and a playback apparatus supplying the electrical signal to the headphones. The headphones include first and second electrodes provided in first and second converters, respectively, so as to be in contact with the user's body. The first converter converts the electrical signal in a right channel into sound. The second converter converts the electrical signal in a left channel into sound. The playback apparatus includes measuring means for measuring a resistance or a capacitance between the first and second electrodes, determination means for determining whether or not the headphones are being worn on the user's body in accordance with the resistance or the capacitance measured by the measuring means, and control means for controlling a state of the playback apparatus in accordance with the determination result of the determination means.

### CROSS REFERENCES TO RELATED APPLICATIONS

The present application is a Continuation of application Ser. No. 11/155,487, filed Jun. 20, 2005, and contains subject matter related to Japanese Patent Application JP 2004-198787 filed in the Japanese Patent Office on Jul. 6, 2004, the entire contents of which are incorporated herein by reference.

### BACKGROUND OF THE INVENTION

1. Field of the Invention

The present invention relates to playback systems, headphones, playback apparatuses and methods, and recording media and programs for controlling the playback apparatuses and methods, and, more particularly, to a playback system capable of further increasing playback time using batteries, headphones, a playback apparatus and method, and a recording medium and a program for controlling the playback apparatus and method.

2. Description of the Related Art

Recently, portable music players for playing back compact disks (CDs), mini disks (MDs), and the like have become available. It is important for portable music players to provide a longer playback time using batteries. Thus, it is desirable that the power of portable music players be turned off when music is not being played back.

FIG. 1 shows a known playback system including headphones 11 and a music player (portable music player) 12.

The headphones 11 are worn over the ears of a user. The headphones 11 convert sound signals supplied from the music player 12 and output the converted sound via headphone cords (cords connecting the headphones 11 and the music player 12 shown in FIG. 1).

The music player 12 reads music data from a storage medium, such as a CD or a MD. The music player 12 plays back sound signals in accordance with the read sound data and supplies the played back sound signals to the headphones 11 via the headphone cords.

In addition, concerning the state of the power supply (a power-supply mode) of the music player 12, a state in which the power of the music player 12 is turned on is referred to as a “power-supply normal mode”, and a state in which power is supplied only to a portion used for operation input to the music player 12 and for controlling the music player 12 and in which the power supply for a portion used for playing back sound is turned off is referred to as a “power-supply hold mode”. In other words, although the entire music player 12 is driven by a battery when the music player 12 is in the power-supply normal mode, only the minimum portion of the music player 12 used for receiving user operations is driven by the battery, and the portion used for playing back sound, which consumes much more power, is not driven by the battery when the music player 12 is in the power-supply hold mode.

More specifically, although the music player 12 supplies sound signals to the headphones 11 via the headphone cords when the music player 12 is in the power-supply normal mode, the music player 12 does not supply sound signals to the headphones 11 via the headphone cords when the music player 12 is in the power-supply hold mode. In other words, although the user is able to listen to music from the headphones 11 when the music player 12 is in the power-supply normal mode, the user is not able to listen to music from the headphones 11 when the music player 12 is in the power-supply hold mode.

In addition, the music player 12 is provided with various buttons for playback, stop, pause, fast-forward, rewind, volume control, and the like. When the user presses a playback button of the music player 12, the music player 12 supplies sound signals to the headphones 11. Then, when the user presses a stop button of the music player 12, the music player 12 stops supplying sound signals to the headphones 11.

Accordingly, the user who is wearing the headphones 11 on his or her ears, the headphones 11 being connected to the music player 12, is able to listen to music.

A process for changing a power-supply mode of the known playback system will be described with reference to FIG. 2.

In step S11, when the user presses the playback button of the music player 12, the music player 12 operates in the power-supply normal mode. In other words, the music player 12 supplies sound signals to the headphones 11 via the headphone cords. In this case, the user who is wearing the headphones 11 on his or her ears is able to listen to music played back by the music player 12.

In step S12, the music player 12 determines whether or not the user presses the stop button.

If it is determined that the user does not press the stop button of the music player 12 in step S12, the music player 12 is kept in the power-supply normal mode. Then, the process proceeds to step S13 to determine whether or not the user presses the pause button of the music player 12.

If it is determined that the user does not press the pause button of the music player 12 in step S13, the music player 12 is kept in the power-supply normal mode. The process returns to step S11 to repeat the foregoing processing.

In contrast, if it is determined that the user presses the pause button of the music player 12 in step S13, the music player 12 causes playback of sound signals to pause (suspend). Then, the process proceeds to step S14 to determine whether or not a predetermined time has passed from the start of the pausing.

If it is determined that the predetermined time has not been passed in step S14, the process repeats the processing in step S14 until the predetermined time has passed.

If it is determined that the predetermined time has passed in step S14, the process proceeds to step S15 to change the power-supply mode of the music player 12 from the power-supply normal mode to the power-supply hold mode. In other words, when the user presses the pause button of the music player 12, after the predetermined time passes, the power-supply mode of the music player 12 is changed from the power-supply normal mode to the power-supply hold mode. As described above, when the pause button of the music player 12 is pressed and the predetermined time has passed, the music player 12 turns off the power.

If it is determined that the user presses the stop button of the music player 12 in step S12, the process proceeds to step S15 to change the power-supply mode of the music player 12 from the power-supply normal mode to the power-supply hold mode. In other words, when the user presses the stop button of the music player 12, the power of the music player 12 is turned off. This means that the power of the music player 12 is turned off in accordance with an explicit user operation.

In step S16, the music player 12 determines whether or not the user presses the playback button of the music player 12.

If it is determined that the user presses the playback button of the music player 12 in step S16, the process returns to step S11 to change the power-supply mode of the music player 12 from the power-supply hold mode to the power-supply normal mode. In other words, when the playback button of the music player 12 is pressed, the power of the music player 12 is turned on. This means that the power of the music player 12 is turned on in accordance with an explicit user operation.

In contrast, if it is determined that the user does not press the playback button of the music player 12 in step S16, the process repeats the processing in step S16 until the user presses the playback button of the music player 12. In other words, since the music player 12 keeps operating in the power-supply hold mode until the next user operation is performed, the power of the music player 12 is kept off. This means that the power-supply mode of the music player 12 does not change without an explicit user operation.

The button of the music player 12 pressed by the user in step S16 is not necessarily the playback button. For example, the button pressed in step S16 may be a fast-forward button, a rewind button, a volume control button, or the like.

As described above, the music player 12 changes the power-supply mode in accordance with an explicit user operation.

In addition, an apparatus that includes sounding means including a movable portion whose position changes in accordance with a worn state on a user's body and that supplies power in accordance with a change in the position of the movable portion is described, for example, in Japanese Unexamined Patent Application Publication No. 2002-305785.

### SUMMARY OF THE INVENTION

However, since the power-supply mode of the music player can be changed only by an explicit user operation, if a user forgets to perform an operation, music continues to be played back until the battery has run out without being noticed by the user.

For example, if the user takes off the headphones without pressing the stop button of the music player and leaves the music player untouched, the battery is wastefully consumed while the user does not notice that music continues to be played back. This reduces the playback time of the music player by the battery.

In addition, if a movable portion is provided in the sounding means, a user feels discomfort when wearing the sounding means. Furthermore, the characteristics (frequency characteristic and the like) of sound listened to by the user are significantly changed due to a slight deviation in position between the user's ears and the headphones. Thus, if the movable portion is provided in the sounding means, the quality of sound changes every time the sounding means is worn.

It is desirable to output sound with a constant sound quality without causing discomfort and to prevent a battery from being wastefully consumed, by using the conductivity of the human body, and by playing back music only when a user is wearing headphones on his or her ears.

A playback system according to an embodiment of the present invention includes headphones and a playback apparatus. The headphones include a first electrode provided in a first converter so as to be in contact with a user′ body, the first converter converting an electrical signal in a right channel into sound, and a second electrode provided in a second converter so as to be in contact with the user's body, the second converter converting the electrical signal in a left channel into sound. The playback apparatus includes measuring means for measuring a resistance or a capacitance between the first electrode and the second electrode, determination means for determining whether or not the headphones are being worn on the user's body in accordance with the resistance or the capacitance measured by the measuring means, and control means for controlling a state of the playback apparatus in accordance with the determination result of the determination means.

Headphones according to an embodiment of the present invention include a first electrode provided in a first converter so as to be in contact with a user's body, the first converter converting an electrical signal in a right channel into sound, and a second electrode provided in a second converter so as to be in contact with the user's body, the second converter converting the electrical signal in a left channel into sound.

A playback apparatus according to an embodiment of the present invention includes measuring means for measuring a resistance or a capacitance between a first electrode provided in a first converter so as to be in contact with a user's body, the first converter converting an electrical signal in a right channel of the headphones into sound, and a second electrode provided in a second converter so as to be in contact with the user's body, the second converter converting the electrical signal in a left channel of the headphones into sound, determination means for determining whether or not the headphones are being worn on the user's body in accordance with the resistance or the capacitance measured by the measuring means, and control means for controlling a state of the playback apparatus in accordance with the determination result of the determination means.

When it is determined that the headphones are not being worn on the user's body in accordance with the determination result of the determination means, the control means may control the state of the playback apparatus such that the playback apparatus stops supplying the electrical signal to the headphones.

When it is determined that the headphones are being worn on the user's body in accordance with the determination result of the determination means, the control means may control the state of the playback apparatus such that the playback apparatus supplies the electrical signal to the headphones.

A playback method according to an embodiment of the present invention includes the steps of measuring a resistance or a capacitance between a first electrode provided in a first converter so as to be in contact with a user's body, the first converter converting an electrical signal in a right channel of the headphones into sound, and a second electrode provided in a second converter so as to be in contact with the user's body, the second converter converting the electrical signal in a left channel of the headphones into sound, determining whether or not the headphones are being worn on the user's body in accordance with the resistance or the capacitance measured in the measuring step, and controlling a state of playback processing in accordance with the determination result in the determining step.

A program recorded on a recording medium according to an embodiment of the present invention for performing playback processing to supply an electrical signal to headphones that are worn on a user's body and that convert the electrical signal into sound includes the steps of measuring a resistance or a capacitance between a first electrode provided in a first converter so as to be in contact with the user's body, the first converter converting the electrical signal in a right channel of the headphones into sound, and a second electrode provided in a second converter so as to be in contact with the user's body, the second converter converting the electrical signal in a left channel of the headphones into sound, determining whether or not the headphones are being worn on the user's body in accordance with the resistance or the capacitance measured in the measuring step, and controlling a state of the playback processing in accordance with the determination result in the determining step.

A program according to an embodiment of the present invention includes the steps of measuring a resistance or a capacitance between a first electrode provided in a first converter so as to be in contact with a user's body, the first converter converting an electrical signal in a right channel of the headphones into sound, and a second electrode provided in a second converter so as to be in contact with the user's body, the second converter converting the electrical signal in a left channel of the headphones into sound, determining whether or not the headphones are being worn on the user's body in accordance with the resistance or the capacitance measured in the measuring step, and controlling a state of the playback processing in accordance with the determination result in the determining step.

In a playback system according to an embodiment of the present invention, headphones include a first electrode provided in a first converter so as to be in contact with a user's body, the first converter converting an electrical signal in a right channel into sound, and a second electrode provided in a second converter so as to be in contact with the user's body, the second converter converting the electrical signal in a left channel into sound, and a playback apparatus measures a resistance or a capacitance between the first electrode and the second electrode, determines whether or not the headphones are being worn on the user's body in accordance with the measured resistance or capacitance, and controls a state of the playback apparatus in accordance with the determination result.

In headphones according to an embodiment of the present invention, a first electrode is provided in a first converter so as to be in contact with a user's body, the first converter converting an electrical signal in a right channel into sound, and a second electrode is provided in a second converter so as to be in contact with the user's body, the second converter converting the electrical signal in a left channel into sound.

In a playback apparatus, a playback method, a recording medium, and a program according to an embodiment of the present invention, a resistance or a capacitance between a first electrode provided in a first converter so as to be in contact with a user's body, the first converter converting an electrical signal in a right channel of headphones into sound, and a second electrode provided in a second converter so as to be in contact with the user's body, the second converter converting the electrical signal in a left channel of the headphones into sound, is measured, a determination of whether or not the headphones are being worn on the user's body is performed in accordance with the measured resistance or capacitance, and a state of the playback processing is controlled in accordance with the determination result.

Accordingly, the power-supply mode can be changed. In addition, sound can be output with a constant quality, and sound can be played back for a longer time.

### BRIEF DESCRIPTION OF THE DRAWINGS

FIG. 1 shows a known playback system including headphones and a music player;

FIG. 2 is a flowchart showing a process for changing a power-supply mode of the known playback system;

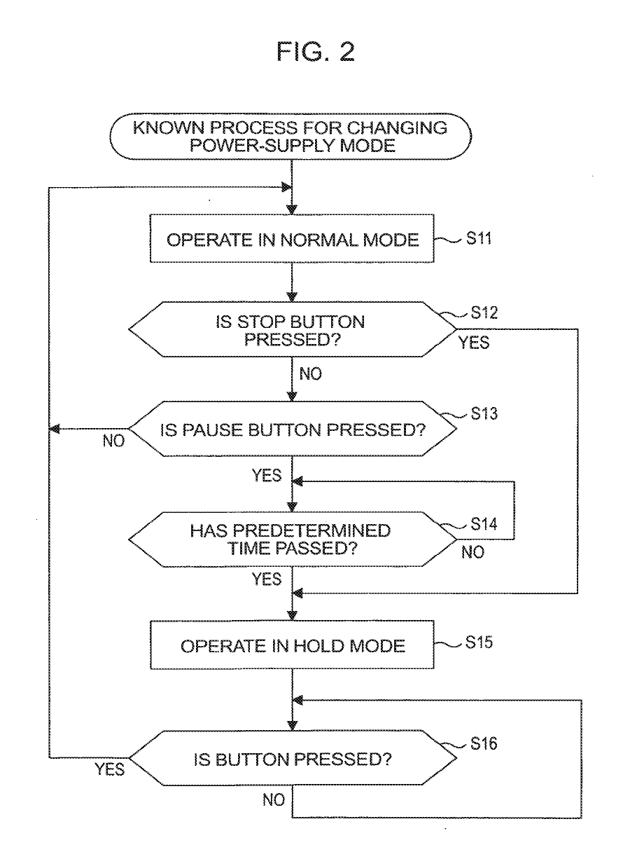

FIG. 3 is a block diagram showing a playback system according to an embodiment of the present invention;

FIG. 4 shows a detailed example of the structure of drivers and earpieces;

FIG. 5 is a flowchart showing a process for changing a power-supply mode using a resistance when a playback button of a music player is pressed; and

FIG. 6 is a flowchart showing a process for changing the power-supply mode when the playback button of the music player is pressed.

### DESCRIPTION OF THE PREFERRED EMBODIMENTS

Embodiments of the present invention will be described with reference to the drawings.

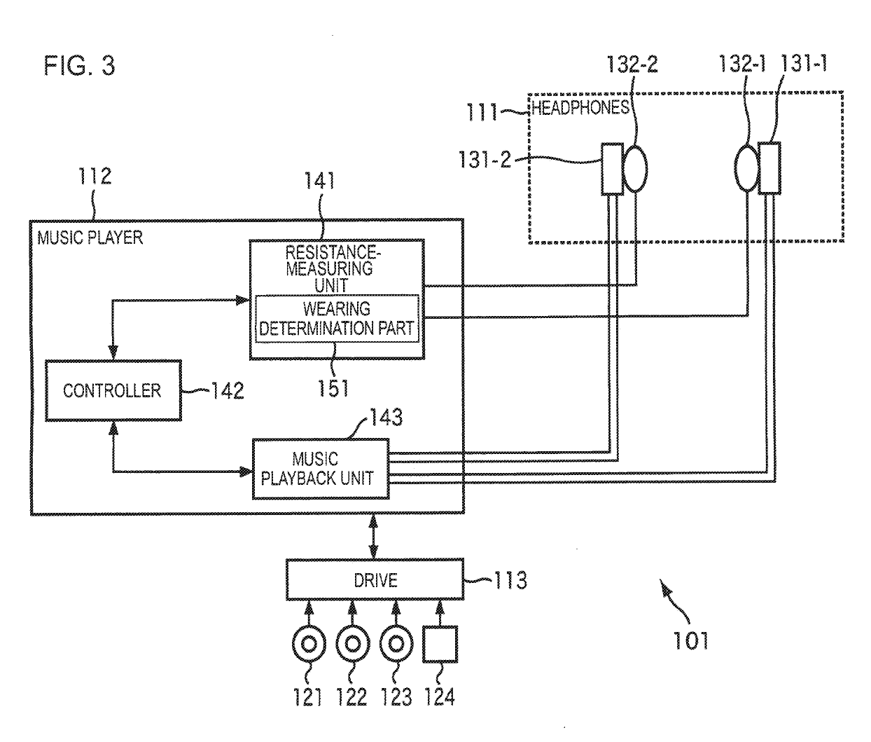

FIG. 3 is a block diagram showing the structure of a playback system 101 according to an embodiment of the present invention.

The playback system 101 includes headphones 111 and a music player 112. The headphones 111 are worn on a user's body. The headphones 111 are an example of headphones converting electrical signals to sound signals. The music player 112 is an example of a playback apparatus supplying electrical signals to the headphones.

In the example shown in FIG. 3, cords connecting drivers 131-1 and 131-2 to a music playback unit 143 of the music player 112 are referred to as “headphone cords”, and cords connecting earpieces 132-1 and 132-2 to a resistance-measuring unit 141 of the music player 112 are referred to as “measuring cords”.

Although it is desirable that each of the headphone cords and the measuring cords be unified using, for example, a three-core cord, they may be independent cords.

The headphones 111 convert sound signals supplied from the music player 112 into sound (acoustic waves (air vibrations)) that can be recognized by the human ear and output the converted sound via the headphone cords.

The headphones 111 may be earphones. In other words, the headphones 111 may be a dynamic type, a capacitor type, an open type, a closed type, an inner-ear type (earphones), an overhead-band type, a clip type, a neck-band type, or the like. In addition, the headphones do not necessarily output sound in accordance with analog sound signals. The headphones may output sound in accordance with digital sound signals.

The headphones 111 include the drivers 131-1 and 131-2 and the earpieces 132-1 and 132-2. The drivers 131-1 and 131-2 are connected to the music playback unit 143 of the music player 112 via the headphone cords, and the earpieces 132-1 and 132-2 are connected to the resistance-measuring unit 141 of the music player 112 via the measuring cords.

The driver 131-1 is made of, for example, a light metal, such as aluminum or magnesium, plastic, or wood. The driver 131-1 covers a sounding body (driver unit) constituted by a coil or a piezo element. Since the sounding body inside the driver 131-1 vibrates in accordance with a sound signal supplied from the music player 112 via the headphone cord, the driver 131-1 converts the sound signal into sound. For example, the driver 131-1 converts sound signals in a left channel into sound (acoustic waves). For example, the driver 131-1 is integrated with the earpiece 132-1. When the earpiece 132-1 is inserted in the user's left ear or worn over the user's left ear, the driver 131-1 is worn on the user's left ear.

The driver 131-2 is made of, for example, a light metal, such as aluminum or magnesium, plastic, or wood. The driver 131-2 covers a sounding body (driver unit) constituted by a coil or a piezo element. Since the sounding body inside the driver 131-2 vibrates in accordance with a sound signal supplied from the music player 112 via the headphone cord, the driver 131-2 converts the sound signal into sound. For example, the driver 131-2 converts sound signals in a right channel into sound (acoustic waves). For example, the driver 131-2 is integrated with the earpiece 132-2. When the earpiece 132-2 is inserted in the user's right ear or worn over the user's right ear, the driver 131-2 is worn on the user's right ear.

The earpiece 132-1 is made of, for example, a soft conductive material, such as a conductive elastomer, conductive rubber, or conductive plastic. The earpiece 132-1 is inserted into the earhole of the user's left ear or worn over the user's left ear so as to cover the user's left ear-concha (ear pinna). The earpiece 132-1 guides or transmits acoustic waves generated by the sounding body inside the driver 131-1 to the user's left ear. In other words, the user is able to listen to sound via the left ear. When the earpiece 132-1 is worn on the user's left ear, the earpiece 132-1 electrically connects the user's left ear and the resistance-measuring unit 141 of the music player 112 via the measuring cord.

The earpiece 132-2 is made of, for example, a soft conductive material, such as a conductive elastomer, conductive rubber, or conductive plastic. The earpiece 132-2 is inserted into the earhole of the user's right ear or worn over the user's right ear so as to cover the user's right ear-concha (ear pinna). The earpiece 132-2 guides or transmits acoustic waves generated by the sounding body inside the driver 131-2 to the user's right ear. In other words, the user is able to listen to sound via the right ear. When the earpiece 132-2 is worn on the user's right ear, the earpiece 132-2 electrically connects the user's right ear and the resistance-measuring unit 141 of the music player 112 via the measuring cord.

Although the driver 131-1 and the earpiece 132-1 are worn on the user's left ear and the driver 131-2 and the earpiece 132-2 are worn on the user's right ear in the above description, obviously, the driver 131-1 and the earpiece 132-1 may be worn on the user's right ear and the driver 131-2 and the earpiece 132-2 may be worn on the user's left ear.

The music player 112 is, for example, a music player, that is, a so-called portable audio player, which contains a storage medium, such as a cassette tape, a CD, a MD, a memory card, or a nonvolatile memory, or a compact hard disk and which is capable of recording and playing back music signals, a personal digital assistance (PDA), or a cellular phone having a music playback function. The music player 112 plays back sound signals and supplies the played back sound signals to the drivers 131-1 and 131-2 of the headphones 111 via the headphone cords.

In addition, concerning the state of the power supply (a power-supply mode) of the music player 112, a state in which the power of the music player 112 is turned on is referred to as a “power-supply normal mode” and a state in which power is supplied only to a portion used for operation input to the music player 112 and for controlling the music player 112 and in which the power supply for a portion used for playing back sound is turned off is referred to as a “power-supply hold mode”. In other words, although the entire music player 112 is driven by a battery when the music player 112 is in the power-supply normal mode, only the minimum portion of the music player 112 used for receiving user operations is driven by the battery, and the portion used for playing back sound, which consumes much more power, is not driven by the battery when the music player 112 is in the power-supply hold mode.

More specifically, although the music playback unit 143 of the music player 112 supplies sound signals to the drivers 131-1 and 131-2 of the headphones 111 via the headphone cords when the music player 112 is in the power-supply normal mode, the music playback unit 143 of the music player 112 does not supply sound signals to the drivers 131-1 and 131-2 of the headphones 111 via the headphone cords when the music player 112 is in the power-supply hold mode. In other words, although the user is able to listen to music from the headphones 111 when the music player 112 is in the power-supply normal mode, the user is not able to listen to music from the headphones 111 when the music player 112 is in the power-supply hold mode.

The power-supply hold mode of the music player 112 includes a so-called “suspend state” or “sleep state”.

In addition, the music player 112 is provided with various buttons for playback, stop, pause, fast-forward, rewind, volume control, and the like. For example, when the user presses a playback button of the music player 112, the music player 112 supplies sound signals to the drivers 131-1 and 131-2 of the headphones 111. Then, when the user presses a stop button of the music player 112, the music player 112 stops supplying sound signals to the drivers 131-1 and 131-2 of the headphones 111.

The music player 112 includes the resistance-measuring unit 141, a controller 142, and the music playback unit 143. The resistance-measuring unit 141 is electrically connected to the earpieces 132-1 and 132-2 of the headphones 111 via the measuring cords. The music playback unit 143 is connected to the drivers 131-1 and 131-2 of the headphones 111 via the headphone cords.

The resistance-measuring unit 141 measures the resistance between the earpieces 132-1 and 132-2 and supplies the measured resistance to a wearing determination part 151. For example, if the headphones 111 are being worn by the user, the resistance-measuring unit 141 measures the resistance between portions of the head of the user that contact the earpieces 132-1 and 132-2 and supplies the measured resistance to the wearing determination part 151.

Since the human body is a conductor having a resistance of several megaohms, the resistance-measuring unit 141 is capable of measuring the resistance (electrical resistance) of the human body by applying a voltage or a current that is too weak to have an effect on the human body. In addition, the resistance-measuring unit 141 is capable of using a bridge circuit, such as a Wheatstone bridge circuit.

The resistance-measuring unit 141 does not necessarily measure resistance. The resistance-measuring unit 141 may measure capacitance.

The resistance-measuring unit 141 includes the wearing determination part 151.

The wearing determination part 151 determines whether or not the user is wearing the headphones 111 in accordance with the resistance measured by the resistance-measuring unit 141 and supplies the determined result (hereinafter, referred to as a “wearing determination result”) to the controller 142. For example, the wearing determination part 151 determines that the user is wearing the headphones 111 when it is determined that the resistance measured by the resistance-measuring unit 141 does not exceed a predetermined threshold value, and the wearing determination part 151 determines that the user is not wearing the headphones 111 when it is determined that the resistance supplied from the resistance-measuring unit 141 exceeds the predetermined threshold value.

The controller 142 controls the music player 112 in accordance with the wearing determination result supplied from the wearing determination part 151. For example, the controller 142 changes the power-supply mode of the music player 112 in accordance with the wearing determination result and controls the music playback unit 143. More specifically, for example, when the wearing determination result supplied from the wearing determination part 151 indicates that the user has taken off the headphones 111, the controller 142 changes the power-supply mode of the music player 112 from the power-supply normal mode to the power-supply hold mode if the music player 112 is in the power-supply normal mode, and the controller 142 keeps the music player 112 in the power-supply hold mode if the music player 112 is in the power-supply hold mode. Accordingly, the controller 142 causes the music playback unit 143 to stop supplying sound signals to the drivers 131-1 and 131-2 of the headphones 111.

In contrast, when the wearing determination result supplied from the wearing determination part 151 indicates that the user is wearing the headphones 111, the controller 142 changes the power-supply mode of the music player 112 from the power-supply hold mode to the power-supply normal mode if the music player 112 is in the power-supply hold mode, and the controller 142 keeps the music player 112 in the power-supply normal mode if the music player 112 is in the power-supply normal mode. Accordingly, the controller 142 causes the music playback unit 143 to supply sound signals to the drivers 131-1 and 131-2 of the headphones 111 via the headphone cords.

In addition, when the user presses a button for playback, stop, pause, fast-forward, rewind, or volume control provided in the music player 112, the controller 142 performs predetermined processing corresponding to the pressed button. For example, when the user presses the playback button of the music player 112, the controller 142 causes the music playback unit 143 to supply sound signals to the drivers 131-1 and 131-2 of the headphones 111 via the headphone cords. Then, when the user presses the stop button of the music player 112, the controller 142 causes the music playback unit 143 to stop supplying sound signals to the drivers 131-1 and 131-2 of the headphones 111.

The music playback unit 143 supplies the sound signals to the headphones 111 via the headphone cords under the control of the controller 142. For example, if the music player 112 is in the power-supply normal mode, the music playback unit 143 supplies the sound signals to the drivers 131-1 and 131-2 of the headphones 111 via the headphone cords under the control of the controller 142. In contrast, if the music player 112 is in the power-supply hold mode, the music playback unit 143 stops supplying the sound signals to the drivers 131-1 and 131-2 of the headphones 111 under the control of the controller 142.

A drive 113 is connected to the music player 112 according to need. When necessary, a magnetic disk 121, an optical disk 122, a magneto-optical disk 123, or a semiconductor memory 124 is installed in the drive 113. The drive 113 reads a program stored in the magnetic disk 121, the optical disk 122, the magneto-optical disk 123, or the semiconductor memory 124 and supplies the read program to the controller 142.

As described above, the resistance-measuring unit 141 and the controller 142 are capable of executing the program read from the magnetic disk 121, the optical disk 122, the magneto-optical disk 123, or the semiconductor memory 124, which is an example of a recording medium.

The drivers 131-1 and 131-2 are configured similarly to each other. When there is no need to distinguish between the drivers 131-1 and 131-2 in the description below, they are, hereinafter, simply referred to as drivers 131. The earpieces 132-1 and 132-2 are configured similarly to each other. When there is no need to distinguish between the earpieces 132-1 and 132-2 in the description below, they are, hereinafter, simply referred to as earpieces 132.

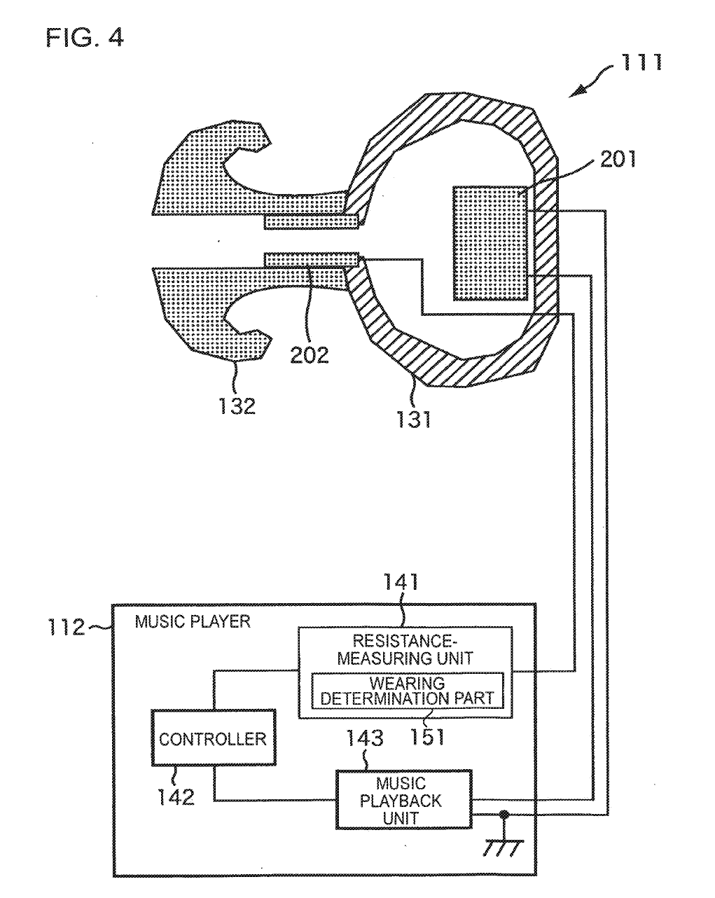

FIG. 4 shows a detailed example of the structure of the drivers 131 and the earpieces 132. The same portions as in FIG. 3 are referred to with the same reference numerals, and the descriptions of those same parts will not be repeated here in an appropriate fashion.

For example, each of driver units 201 includes a sounding body constituted by a coil or a piezo element disposed in a predetermined magnetic field and is provided inside the corresponding driver 131. Each of the driver units 201 vibrates in accordance with a sound signal supplied from the music playback unit 143 of the music player 112 via the headphone cord to convert the sound signal into sound.

Since the driver units 201 are provided inside the drivers 131, when the earpieces 132 are inserted into the user's earholes or worn over the user's ears so as to cover the user's ear-conchas (ear pinnae), the driver units 201 vibrate in accordance with sound signals supplied from the music playback unit 143 via the headphone cords, and the user listens to music via the ears. The driver units 201 are connected to the music player 112 using headphone cords each constituted by a signal wire, which is on a so-called “hot side”, and a ground wire, which is on a so-called “cold side”. The ground wire is connected to the ground of the music player 112. The ground wire of the driver 131-1 and the ground wire of the driver 131-2 may be unified.

Conductors 202 are made of, for example, conductive materials, such as conductive elastomers, conductive rubber, conductive plastic, or metals. The conductors 202 are provided inside the earpieces 132 so as to be in contact with the earpieces 132. The conductors 202 are connected to the resistance-measuring unit 141 via the measuring cords.

In other words, the earpieces 132-1 and 132-2 electrically connect the user's body to the resistance-measuring unit 141 via the conductors 202 provided inside the earpieces 132-1 and 132-2. Thus, if it is desired that the earpieces 132 fit the shape of the user's ears or if the earpieces 132 are worn out, only the earpieces 132 can be replaced with new earpieces easily. The earpieces 132 and the conductors 202 may be integrated with each other.

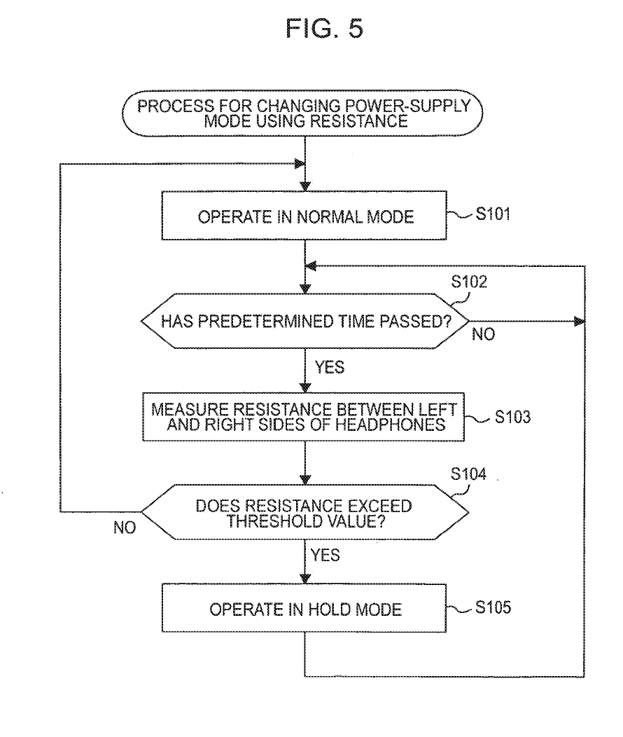

A process for changing a power-supply mode using a resistance when the playback button of the music player 112 is pressed is described next with reference to the flowchart shown in FIG. 5.

In step S101, the controller 142 causes the music player 112 to operate in the power-supply normal mode. In other words, the music playback unit 143 supplies sound signals to the headphones 111 via the headphone cords. The user who is wearing the headphones 111 on his or her ears is able to listen to music played back by the music player 112.

In step S102, the controller 142 determines whether or not a predetermined time has passed.

The predetermined time is equal to the update interval for performing processing in steps S103 and S104. In other words, the predetermined time is equal to the time interval of the controller 142 causing the resistance-measuring unit 141 to measure the resistance between the conductors 202 provided on the left and right sides of the headphones 111.

For example, by setting the update interval to one second, the processing in steps S103 and S104 is performed at one-second intervals. The update interval can be set in an appropriate fashion. By setting a short update interval, the power-supply mode of the music player 112 is changed to the power-supply hold mode immediately after the user takes off the headphones 111. Thus, wasteful consumption of the battery of the music player 112 can be reduced. In contrast, if a long update interval is set, the load on the controller 142 can be reduced.

Instead of setting the predetermined time described above, the processing in steps S103 and S104 may be constantly performed. In this case, after the processing in step S101, the processing in step S102 is omitted, and the processing in step S103 is performed.

If it is determined that the predetermined time has not been passed in step S102, the processing in step S102 is repeated until the predetermined time has passed.

In contrast, if it is determined that the predetermined time has passed in step S102, the resistance-measuring unit 141 measures the resistance between the left and right sides of the headphones 111 in step S103. The resistance-measuring unit 141 supplies the measured resistance to the wearing determination part 151. For example, the resistance-measuring unit 141 measures the resistance between the earpieces 132-1 and 132-2 and supplies the measured resistance to the wearing determination part 151 via the conductors 202 and the measuring cords.

If both the earpieces 132-1 and 132-2 are being worn on the user's ears, the resistance-measuring unit 141 measures the resistance between the user's left and right ears. In contrast, if one of the earpieces 132-1 and 132-2 is not being worn on the user's ear, since the earpieces 132-1 and 132-2 are disconnected from each other, the resistance-measuring unit 141 measures an infinitely large resistance.

In step S104, the wearing determination part 151 determines whether or not the resistance supplied from the resistance-measuring unit 141 exceeds a predetermined threshold value.

If it is determined that the resistance does not exceed the threshold value in step S104, it is determined that the headphones 111 are being worn on the user's ears. The process returns to step S101 to repeat the forgoing processing. In other words, the music player 112 is kept in the power-supply normal mode, and sound continues to be played back.

In contrast, if it is determined that the resistance exceeds the threshold value in step S104, it is determined that the headphones 111 are not being worn by the user. The process proceeds to step S105 to change the power-supply mode of the music player 112 from the power-supply normal mode to the power-supply hold mode.

In other words, it is determined whether or not the headphones 111 are being worn on the user's body in accordance with the determination result of whether or not the resistance exceeds the threshold value. If it is determined that the headphones 111 are not being worn on the user's body, the power of the music player 112 is turned off. In other words, the power of the music player 112 is turned off without an explicit user operation, that is, without being noticed by the user.

As described above, if the headphones 111 are taken off by the user, the power of the music player 112 is turned off without an explicit user operation. Thus, the battery of the music player 112 can be prevented from being wastefully consumed.

The process returns to step S102 to repeat the foregoing processing. After the predetermined time passes in step S102, the resistance-measuring unit 141 measures the resistance between the left and right sides of the headphones 111 again in step S103, and the wearing determination part 151 determines whether or not the headphones 111 are being worn by the user in accordance with the measured resistance between the left and right sides of the headphones 111 supplied from the resistance-measuring unit 141 in step S104.

In other words, when the user takes off the headphones 111, the power-supply mode of the music player 112 is changed from the power-supply normal mode to the power-supply hold mode. Then, when the user wears the headphones 111, the power-supply mode of the music player 112 can be changed from the power-supply hold mode to the power-supply normal mode again. In other words, the music player 112 operates in the power-supply hold mode when the user is not wearing the headphones 111, and the music player 112 operates in the power-supply normal mode when the user is wearing the headphones 111. The change of the power-supply mode of the music player 112 can be performed without an explicit user operation, that is, without being noticed by the user.

As described above, since music can be played back only when the user is wearing the headphones 111 on his or her ears, the battery of the music player 112 can be prevented from being wastefully consumed.

When the power-supply mode of the music player 112 is changed from the power-supply normal mode to the power-supply hold mode, the position of music being played back by the music playback unit 143 (hereinafter, referred to as a “playback position”) is stored in a storage device (for example, a storage unit provided inside the controller 142) provided in the music player 112. Then, when the power-supply mode of the music player 112 is changed from the power-supply hold mode to the power-supply normal mode again, music starts being played back from the playback position stored in the storage device. Thus, music is placed in the pause state only when the user is not wearing the headphones 111.

As described above, when the user takes off the headphones 111, for example, in order to listen to an announcement on the train, the playback of music immediately pauses. When the user places the headphones 111 on his or her ears again, music starts being played back from the position at which playback stopped. Thus, the user does not miss any of the music played back by the music player 112.

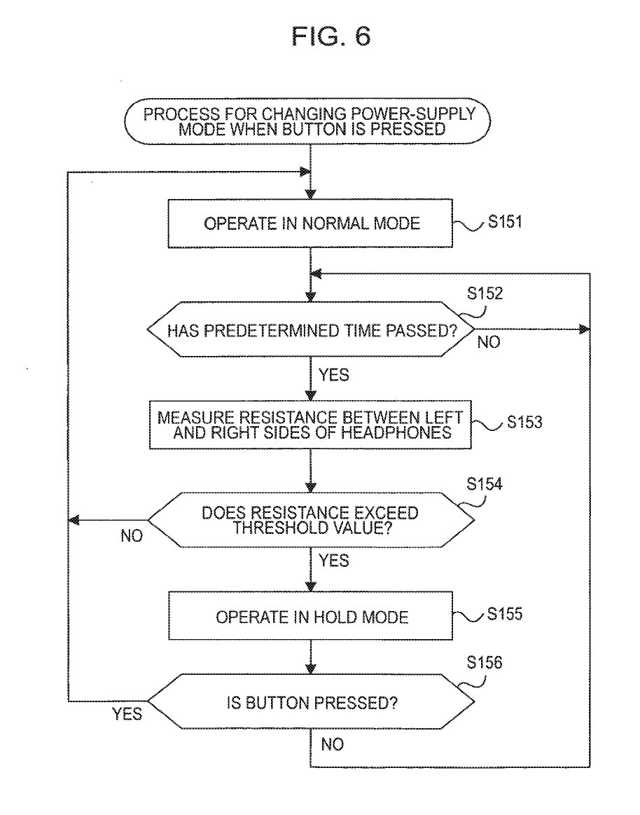

A process for changing a power-supply mode when the playback button of the music player 112 is pressed is described next with reference to FIG. 6.

The processing in steps S151 to S155 is equal to the processing in steps S101 to S105 in FIG. 5, and the description of this processing is omitted here. In addition, here, the music player 112 operates in the power-supply hold mode by the processing in step S155.

In step S156, the controller 142 determines whether or not the user presses the playback button of the music player 112.

If it is determined that the user presses the playback button of the music player 112 in step S156, the process returns to step S151 to change the power-supply mode of the music player 112 from the power-supply hold mode to the power-supply normal mode. In other words, when the playback button of the music player 112 is pressed, the power of the music player 112 is turned on.

At this time, the music playback unit 143 of the music player 112 supplies sound signals to the headphones 111 via the headphone cords. Thus, the user who is wearing the headphones 111 on his or her ears is able to listen to music.

In contrast, if it is determined that the user does not press the playback button of the music player 112 in step S156, the process returns to step S152 to repeat the foregoing processing. In other words, since the music player 112 keeps operating in the power-supply hold mode until the user wears the headphones 111 or presses the playback button of the music player 112, the power of the music player 112 is kept off.

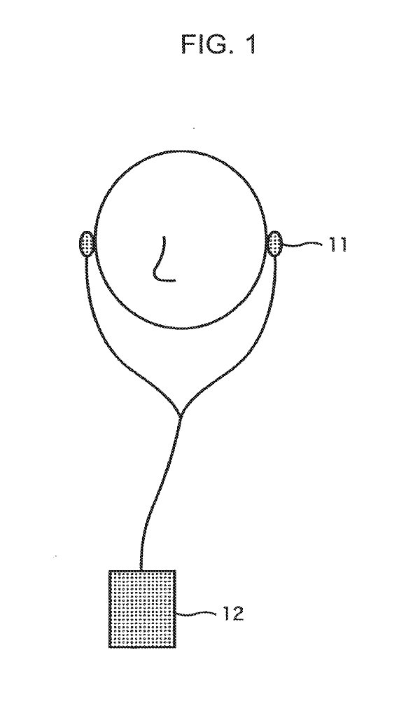

As described above, even in a case where the power-supply mode of the music player 112 is switched using the conductivity of the human body, when the user presses a button (for example, a playback button) provided in the music player 112, the power-supply mode of the music player 112 is changed to the power-supply normal mode, similarly to the known music player 12 shown in FIG. 1.

The button of the music player 112 pressed by the user is not necessarily the playback button. For example, a fast-forward button, a rewind button, a volume control button, or the like may be pressed.

In addition, wireless communication, that is, so-called “cordless” communication, may be performed between the headphones 111 and the music player 112. In this case, each of the headphones 111 and the music player 112 is provided with a wireless communication controller performing wireless communication using infrared rays or radio waves.

In addition, the headphones 111 may transmit sound using so-called “bone conduction”.

In addition, the resistance-measuring unit 141 may be provided in the headphones 111.

Furthermore, when the user takes off the headphones 111, sound signals played back by the music player 112 may be stopped or temporarily suspended or the volume of sound output from the headphones 111 may be reduced, irrespective of the power-supply mode of the music player 112.

As described above, using the conductivity of the human body, music can be played back only when the user is wearing the headphones 111 on his or her ears. Thus, the battery of the music player 112 can be prevented from being wastefully consumed. In other words, the driving time of the battery of the music player 112 can be increased.

The foregoing series of processing may be performed by hardware or software. If the foregoing series of processing is performed by software, a program constituting the software is installed from a recording medium on a computer installed in dedicated hardware or, for example, a general-purpose personal computer that is capable of performing various functions by installing various programs.

The recording medium not only includes a package medium, such as the magnetic disk 121 (including a flexible disk), the optical disk 122 (including a compact disk-read only memory (CD-ROM)), the magneto-optical disk 123 (including a MiniDisk (MD)), or the semiconductor memory 124, which records the program and is distributed in order to provide the program to a user independent of the computer, but also includes a ROM (not shown) or the like which records the program and is built in the computer to be provided to the user.

The program for performing the series of foregoing processing may be installed on the computer via wired or wireless communication, such as a local area network, the Internet, or digital broadcasting, using an interface, such as a router or a modem, according to need.

In this specification, steps for the program recorded in the recording medium are not necessarily performed in chronological order in accordance with the written order. The steps may be performed in parallel or independently without being performed in chronological order.

In addition, in this specification, the term “system” represents the entire apparatus constituted by a plurality of apparatuses.

It should be understood by those skilled in the art that various modifications, combinations, subcombinations and alterations may occur depending on design requirements and other factors insofar as they are within the scope of the appended claims or the equivalents thereof.

What is claimed is:

1. An information processing apparatus, comprising:
a power supply configured to operate in a first power supply mode and a second power supply mode;
a user interface;
sound playback circuitry;
measurement circuitry configured to measure an electrical condition and output a first electrical signal based on a result of the measurement; and
a controller configured to automatically switch the power supply between the first power supply mode and the second power supply mode in response to the first electrical signal, wherein
in a case where the power supply is operating in the first power supply mode, the power supply is configured to supply power to the user interface and to the sound playback circuitry, and
in a case where the power supply is operating in the second power supply mode, the power supply is configured to supply power to the user interface but not to the sound playback circuitry.

2. The information processing apparatus according to claim 1, wherein, in the case where the power supply is operating in the second power supply mode, the power supply is configured to not supply power to any part of the information processing apparatus other than the user interface.

3. The information processing apparatus according to claim 1, wherein the measurement circuitry is configured to repeatedly perform the measurement at a predetermined time interval.

4. The information processing apparatus according to claim 1, wherein the measurement circuitry is configured to constantly perform the measurement.

5. The information processing apparatus according to claim 1, wherein the electrical condition is a resistance between a first earpiece and a second earpiece through a user body.

6. The information processing apparatus according to claim 5, wherein the measurement circuitry includes a bridge circuit.

7. The information processing apparatus according to claim 1, wherein the electrical condition is a capacitance between a first earpiece and a second earpiece through a user body.

8. The information processing apparatus according to claim 1, wherein
the user interface is configured to generate a second electrical signal in response to a user input; and
the controller is configured to automatically switch the power supply between the first power supply mode and the second power supply mode in response to the second electrical signal.

9. The information processing apparatus according to claim 1, wherein, in the case where the power supply is operating in the first power supply mode, the sound playback circuitry is configured to generate a sound signal.

10. The information processing apparatus according to claim 1, further comprising a memory card configured to store music signals.

11. A method of operating an information processing apparatus including a power supply configured to operate in a first power supply mode and a second power supply mode, a user interface, sound playback circuitry, measurement circuitry, and a controller, the method comprising:
measuring an electrical condition and outputting a first electrical signal by the measurement circuitry based on a result of the measurement;
automatically switching the power supply by the controller between the first power supply mode and the second power supply mode in response to the first electrical signal;
in a case where the power supply is operating in the first power supply mode, supplying power from the power supply to the user interface and to the sound playback circuitry; and
in a case where the power supply is operating in the second power supply mode, supplying power from the power supply to the user interface but not to the sound playback circuitry.

12. The method according to claim 11, further comprising:
in the case where the power supply is operating in the second power supply mode, not supplying power from the power supply to any part of the information processing apparatus other than the user interface.

13. The method according to claim 11, further comprising repeatedly performing the measurement at a predetermined time interval.

14. The method according to claim 11, further comprising constantly performing the measurement.

15. The method according to claim 11, wherein the electrical condition is a resistance between a first earpiece and a second earpiece through a user body.

16. The method according to claim 15, wherein the measurement circuitry includes a bridge circuit.

17. The method according to claim 11, wherein the electrical condition is a capacitance between a first earpiece and a second earpiece through a user body.

18. The method according to claim 11, further comprising:
generating a second electrical signal by the user interface in response to a user input; and
automatically switching the power supply by the controller between the first power supply mode and the second power supply mode in response to the second electrical signal.

19. The method according to claim 11, further comprising:
in the case where the power supply is operating in the first power supply mode, generating a sound signal by the sound playback circuitry.

20. The method according to claim 11, wherein the information processing apparatus further comprises a memory card configured to store music signals.
